(19) United States
(12) Patent Application Publication
(10) Pub. No.: US 2018/0116768 A1
(43) Pub. Date: May 3, 2018

(54) ROOT IMPLANT

(71) Applicant: TAIWAN SHAN YIN INTERNATIONAL CO., LTD., KAOHSIUNG CITY (TW)

(72) Inventors: KOU-TSAIR SU, KAOHSIUNG CITY (TW); YU-JUNG SU, KAOHSIUNG CITY (TW)

(21) Appl. No.: 15/341,202

(22) Filed: Nov. 2, 2016

(51) Int. Cl. A61C 8/00; A61C 8/02

(52) U.S. Cl. CPC A61C 8/0037; A61C 2008/0046; A61C 8/0006; A61C 8/0024

(57) ABSTRACT

A root implant includes a body portion, a drilling portion formed on the body portion, a positioning hole formed opposite to the drilling portion, and a thread portion spiraled on the body portion. The body portion and the coarse thread have respective first openings and second openings spaced apart by equal distances. The first openings and second openings accommodate accretions grown from the alveolar bone when the root implant interfaces with the alveolar bone. The body portion and the coarse thread includes first joint sections and second joint sections formed between any two of the first openings and the second openings respectively to allow the accretions to clamber and link together to provide a tight combination between the root implant and the alveolar bone, preventing the loosening problem caused by an external force and promoting a positioning effect of the root implant.

### BACKGROUND OF THE INVENTION

### 1. Field of the Invention

This invention relates to an implant and relates particularly to a root implant can be fixed to the alveolar bone firmly after the root implant is placed in position.

### 2. Description of the Related Art

In the field of dentistry, dental implants are widely used for treating dental defects by implanting the dental implants into the alveolar bone. The aforementioned treatment is simply aimed at treating a single dental defect to ensure that the healed dental defect can appear like original teeth and able to bear a biting force. During the convalescence of the alveolar bone, the alveolar bone will proliferate accretions. Although the accretions can integrate with the dental implant, in view of a slippery surface of the dental implant, the slight displacements caused by an external force may result in the loosening problem of the accretions while the alveolar bone is recovered gradually. Hence, an integrated fixing effect is decreased.

In order to increase the integrated fixing effect between the dental implant and the alveolar bone, some firms advance an improved dental implant which has several pellets attached thereon. The pellets of the improved dental implant are further processed by a multi-melting sintering method to therefore form several holes on a surface of the dental implant so that the accretions can adhere to the holes, thereby providing a solid combination between the dental implant and the alveolar bone. Although the improved dental implant is processed by the multi-melting sintering method to form several holes to accommodate the accretions, an outer diameter and a depth of each hole are hardly to keep identical during the multi-melting sintering process. In other words, sizes of the holes maybe different from each other so that qualities of the holes are incontrollable. Further, the multi-melting sintering method causes the surfaces of the holes to become slippery. Thus, the holes are unable to accommodate the accretions successfully to result in an ineffective combination between the dental implant and the alveolar bone. Moreover, because the pellets are distributed on the surface of the dental implant irregularly, the holes will be spaced from each other by irregular distances after the pellets are sintered. Hence, the accretions are unable to form toward a regular direction effectively when the accretions clamber between any two of the holes. Furthermore, the sintered pellets may even result in the possibility of remaining the corrosive acid. Hence, the integrated fixing effect is not preferable and this requires an improvement.

### SUMMARY OF THE INVENTION

The object of this invention is to provide a root implant which accommodates accretions regularly in order to link the root implant with the alveolar bone fixedly, prevent the loosening problem caused by an external force and increase the positioning effect of the root implant.

The root implant of this invention comprises a body portion, a drilling portion fitted on a first side of the body portion, a positioning hole formed on a second side of the body portion opposite to the drilling portion, and a thread portion spirally fitted on the body portion. The body portion is provided with a plurality of first openings formed thereon and a first joint section formed between any two of the first openings. The thread portion is composed of a coarse thread close to the drilling portion and a fine thread connected with the coarse thread and close to the positioning hole. The coarse thread is provided with a plurality of second openings formed thereon and a second joint section formed between any two of the second openings. Further, the first openings and second openings are made by a high-energy optothermal method to organize the first openings on the body portion in an equidistant arrangement and organize the second openings on the coarse thread in an equidistant arrangement. Thus, when accretions are grown from the alveolar bone toward the root implant, the accretions can adhere to the first openings and second openings after the root implant is placed in position. Meanwhile, the equidistant arrangements of the first openings and second openings and the installation of the first joint sections and second joint sections enable the accretions to reproduce toward an identical direction and distribute uniformly. Therefore, the root implant can fix to the alveolar bone firmly, increase the stability between the root implant and the alveolar bone, prevent the accretions from being unfastened by an external force, and achieve the preferable positioning effect of the root implant.

Preferably, each first opening has at least one first pore formed thereon.

Preferably, each second opening has at least one second pore formed thereon.

Preferably, the fine thread is provided with a plurality of third openings formed thereon and a third joint section are formed between any two of the third openings.

Preferably, each third opening has at least one third pore formed thereon.

### BRIEF DESCRIPTION OF THE DRAWINGS

FIG. 1 is a schematic view showing a first preferred embodiment of this invention;

FIG. 1a is an enlarged view showing a partial element of FIG. 1;

FIG. 2 is a schematic view showing a simulation that the root implant implants into the alveolar bone;

FIG. 3 is a schematic view showing a second preferred embodiment of this invention;

FIG. 3a is an enlarged view showing a partial element of the coarse thread of FIG. 3;

FIG. 3b is an enlarged view showing a partial element of the fine thread of FIG. 3;

FIG. 4 is a schematic view showing a third preferred embodiment of this invention;

FIG. 4a is an enlarged view showing a partial element of the coarse thread of FIG. 4;

FIG. 4b is an enlarged view showing a partial element of the fine thread of FIG. 4;

FIG. 5 is a schematic view showing a fourth preferred embodiment of this invention;

FIG. 5a is an enlarged view showing a partial element of the coarse thread of FIG. 5;

FIG. 5b is an enlarged view showing a partial element of the fine thread of FIG. 5;

FIG. 6 is a schematic view showing a fifth preferred embodiment of this invention;

FIG. 6a is an enlarged view showing a partial element of the coarse thread of FIG. 6; and

FIG. 6b is an enlarged view showing a partial element of the fine thread of FIG. 6.

### DETAILED DESCRIPTION OF THE PREFERRED EMBODIMENTS

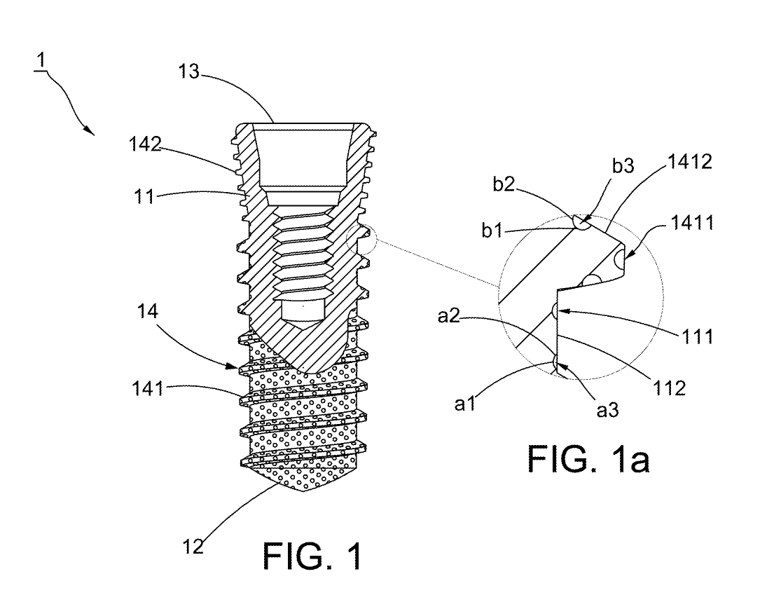

Referring to FIG. 1, a first preferred embodiment of a root implant 1 of this invention includes a body portion 11, a drilling portion 12 fitted on a first side of the body portion 11, a positioning hole 13 formed on a second side of the body portion 11 and opposed to the drilling portion 12, and a thread portion 14 fitted on the body portion 11 spirally. Referring to FIG. 1a, the body portion 11 has a plurality of first openings 111 formed thereon. Any two of the first openings 111 define a first joint section 112. Each first opening 111 is further divided into a first bottom wall a1, a first surrounding wall a2 connected with the first bottom wall a1, and a first accommodation room a3 defined by each first bottom wall a1 and each first surrounding wall a2. Each first accommodation room a3 communicates with the outside. Meanwhile, the first openings 111 are processed by a high-energy optothermal method to form the first openings 111 with precise dimensions and equidistant arrangements on the body portion 11 and form each first bottom wall a1 and each first surrounding wall a2 with ragged surfaces.

The thread portion 14 includes a coarse thread 141 close to the drilling portion 12 and a fine thread 142 close to the positioning hole 13 and connected with the coarse thread 141. Hence, the root implant 1 takes advantages that the coarse thread 141 and the fine thread 142 are disposed on the body portion 11 to cut the alveolar bone 2 (not shown) effectively. The coarse thread 141 executes the drilling operation first and the fine thread 142 then follows the drilling tracks of the coarse thread 141 to further screw into the alveolar bone 2, thereby fixing the root implant 1 to the alveolar bone 2 steadily. In this preferred embodiment, the coarse thread 141 has a plurality of second openings 1411 formed thereon. Any two of the second openings 1411 define a second joint section 1412. Each second opening 1411 is further divided into a second bottom wall b1, a second surrounding wall b2 connected with the second bottom wall b1, and a second accommodation room b3 defined by each second bottom wall b1 and each second surrounding wall b2, as shown in FIG. 1a. Each second accommodation room b3 communicates with the outside. Simultaneously, the second openings 1411 are processed by the high-energy optothermal method to provide the second openings 1411 with identical dimensions and equidistant arrangements on the coarse thread 141 and further provide each second bottom wall b1 and each second surrounding wall b2 with uneven surfaces.

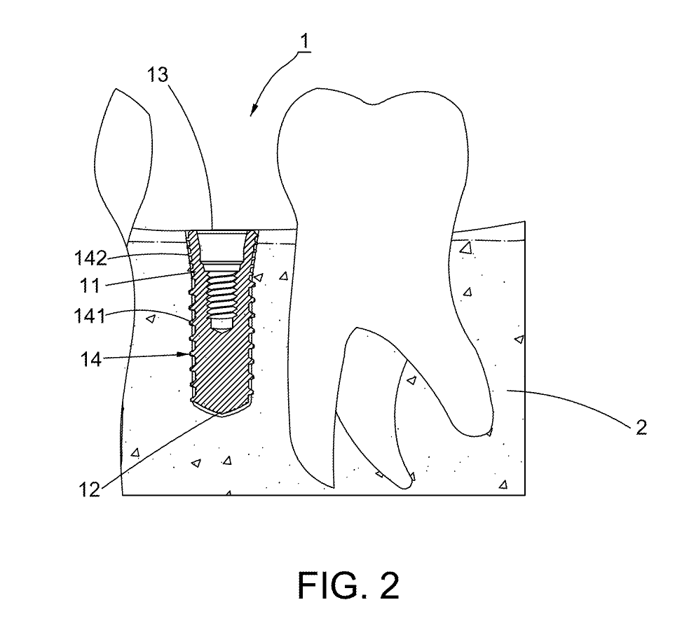

Referring to FIGS. 1a and 2, to proceed with an implant operation, the drilling portion 12 is positioned at a pre-opened implanting hole (not shown) of the alveolar bone 2 and the positioning hole 13 receives a force from a driving tool (not shown) in order to drive the coarse thread 141 of the drilling portion 12 to cut an inner wall of the implanting hole. The coarse thread 141 therefore contacts with the inner wall of the implanting hole extensively and further screws into the implanting hole. The fine thread 142 then follows the drilling tracks of the coarse thread 141 to execute the following drilling operation and contacts with the inner wall of the implanting hole in small area. Hence, the root implant 1 takes advantages of the coarse thread 141 and fine thread 142 of the thread portion 14 to allow the root implant 1 to screw into the alveolar bone 2 quickly, thereby reducing patients' discomfort during the implant operation and achieving a stable positioning effect at the primary implant operation. Further, the first accommodation rooms a3 and second accommodation rooms b3 allow accretions proliferated from the alveolar bone 2 to accommodate therein during the convalescence of the alveolar bone 2 after the implant operation is finished. Besides, the ragged surfaces of the first bottom walls a1, the second bottom walls b1, the first surrounding walls a2 and the second surrounding walls b2 allow the accretions to adhere to the root implant 1 tightly. Moreover, the first joint sections 112 and second joint sections 1412 allow the accretions to clamber and respectively move from one first opening 111 and second opening 1411 toward another first opening 111 and second opening 1411 which are next to the first joints sections 112 and second joints sections 1412. Hence, the accretions within any two of the first openings 111 and any two of the second openings 1411 can respectively engage to each other at the first joint sections 112 and second joint sections 1412 to form a tight combination between the root implant 1 and the alveolar bone 2. Furthermore, the equidistant arrangements of the first openings 111 and second openings 1411 allow the accretions to distribute toward an identical direction, thereby fixing the root implant 1 to the alveolar bone 2 firmly. When the root implant 1 is moved by an improper external force caused during the convalescence of the alveolar bone 2, the fixed connections between any two of the accretions prevent the root implant 1 from loosening, thereby enhancing the combination between the root implant 1 and the alveolar bone 2 greatly and increasing the positioning effect of the root implant 1 effectively.

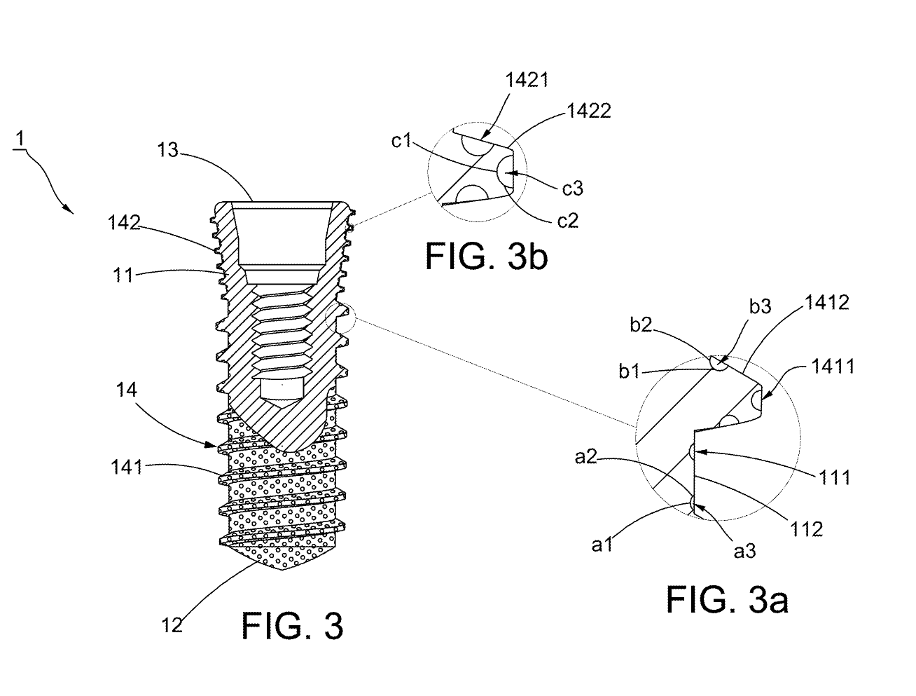

Referring to FIGS. 3 and 3b shows a second preferred embodiment of the root implant 1 of this invention. The correlated elements, the concatenation of elements, the operation and objectives of the second preferred embodiment are the same as those of the first preferred embodiment. This embodiment is characterized in that the fine thread 142 has a plurality of third openings 1421 formed thereon. Any two of the third openings 1421 define a third joint section 1422. Each third opening 1421 is further divided into a third bottom wall c1, a third surrounding wall c2 connected to the third bottom wall c1, and a third accommodation room c3 defined by each third bottom wall b1 and each third surrounding wall c2, as shown in FIG. 3b. Each third accommodation room c3 communicates with the outside. In the meantime, the third openings 1421 are processed by the high-energy optothermal method to allow the third openings 1421 to have precise dimensions and equidistant arrangements and allow each third bottom wall c1 and each third surrounding wall c2 to be processed with rough surfaces. Referring to FIG. 3a, the first openings 111, the second openings 1411 and the third openings 1421 formed on the body portion 11′ the coarse thread 141 and the fine thread 142 respectively can provide different tight forces to fasten the root implant 1 to the alveolar bone 2 (not shown) effectively. Further, the first joint sections 112, the second joint sections 1412 and the third joint sections 1422 allow the accretions to clamber in order to prevent the possibility that the accretions may loosen from the root implant 1 by the external force. Thus, the root implant 1 attains a preferable positioning effect.

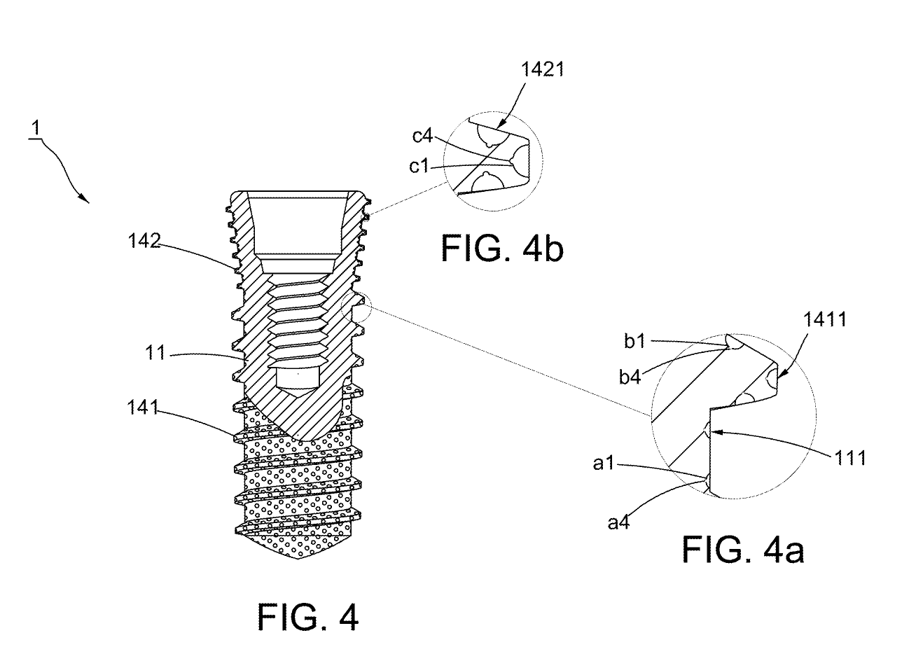

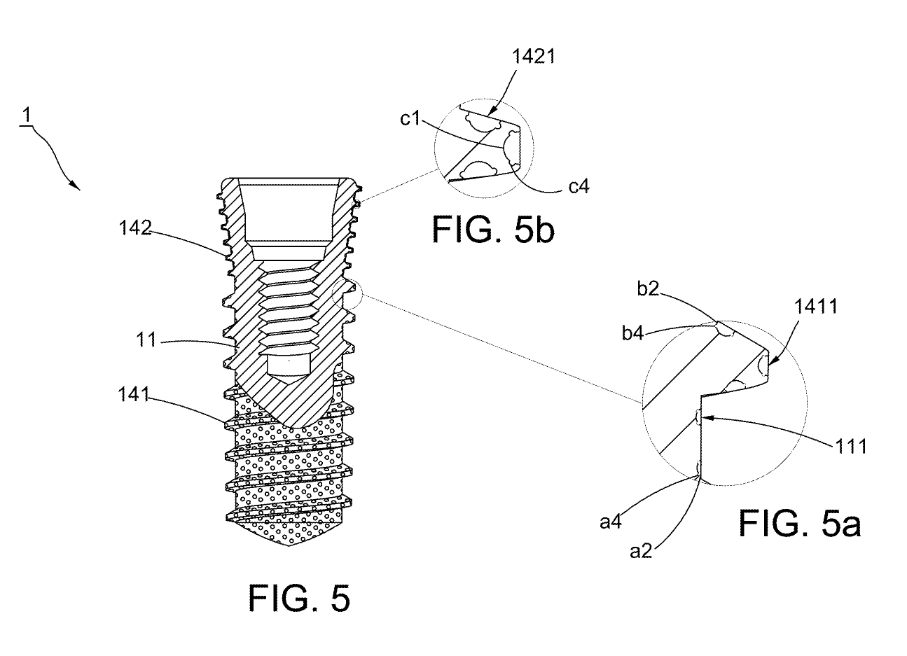

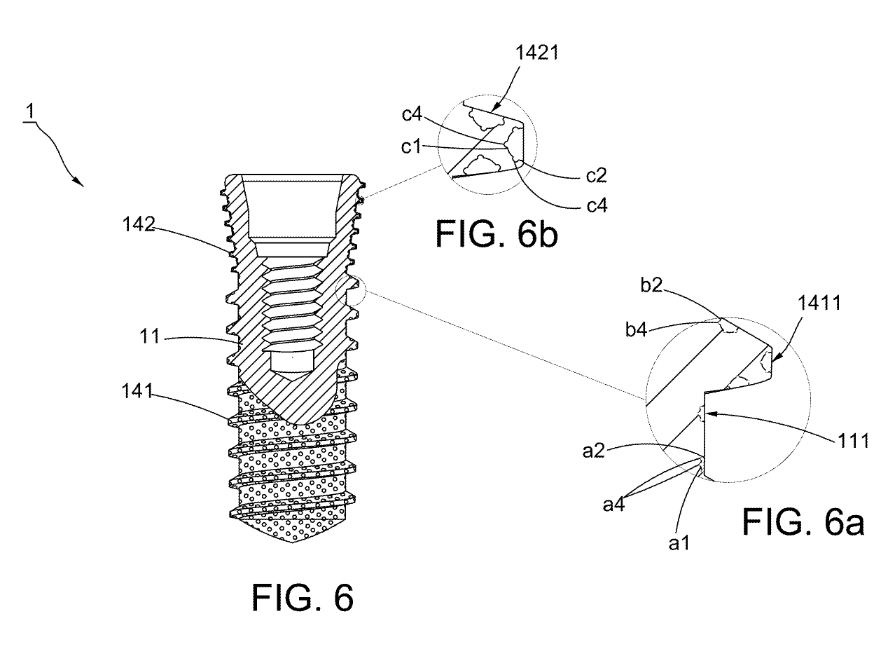

Referring to FIG. 4 showing a third preferred embodiment of the root implant 1 of this invention includes the same correlated elements, the same concatenation of elements, and the same operation and objectives as those of the first preferred embodiment. In this preferred embodiment, each first bottom wall a1 has at least one first pore a4 formed thereon. Each second bottom wall b1 has at least one second pore b4 formed thereon. Each third bottom wall c1 has at least one third pore c4 formed thereon, as shown in FIGS. 4a and 4b. Besides, referring to FIGS. 5a and 5b showing a fourth preferred embodiment, each first surrounding wall a2 has at least one first pore a4 fitted thereon. Each second surrounding wall b2 has at least one second pore b4 fitted thereon. Each third surrounding wall c2 has at least one third pore c4 fitted thereon. Optionally, at least one first pore a4 can be formed on each first bottom wall a1 and each first surrounding wall a2 simultaneously. At least one second pore b4 can be formed on each second bottom wall b1 and each second surrounding wall b2 simultaneously. At least one third pore c4 can be formed on each third bottom wall c1 and each third surrounding wall c2 simultaneously, as shown in FIGS. 6a and 6b showing a fifth preferred embodiment. Thus, the root implant 1 can be arranged according to different treatments. Further, the first pore a4, the second pore b4 and the third pore c4 are processed by the high-energy optothermal method. Thereinafter, the fifth preferred embodiment is taken as an example, as shown in FIGS. 6a and 6b.

Referring to FIGS. 6 and 6a, in use, the accretions grown from the alveolar bone 2 (not shown) can extend to each first opening 111, each second opening 1411 and each third opening 1421 and further adhere to each first pore a4, each second pore b4 and each third pore c4 respectively, thereby enhancing the stability between the root implant 1 and the alveolar bone 2 . Moreover, each first pore a4 , each second pore b4 and each third pore c4 can accommodate the accretions therein whereby the root implant 1 can fix to the alveolar bone 2 firmly without loosening which is caused by the external force. Hence, the positioning effect of the root implant 1 is effectively increased.

To sum up, the root implant of this invention takes advantages that the first openings and the second openings are processed by the high-energy optothermal method to respectively form on the coarse thread of the thread portion and the body portion by equal distances. Therefore, the accretions can adhere to the first accommodation room of each first opening and the second accommodation room of each second opening when the root implant set in the alveolar bone. Further, the first joint section and the second joint section respectively disposed between any two of the first openings and any two of the second openings allow the accretions to accommodate in the first openings and the second openings toward the regular direction. Hence, the root implant can fasten to the alveolar bone tightly without loosening which is caused by the external force, thereby strengthening the combination between the root implant and the alveolar bone effectively and further increasing the positioning effect of the root implant greatly after the root implant is placed in position.

1. A root implant, comprising:
a body portion extending in an axial direction between first and second axial ends, a drilling portion formed at the first axial end of said body portion, a positioning hole formed at the second axial end of said body portion; and
a thread portion spirally disposed about said body portion;
wherein said body portion has a plurality of first recess openings formed thereon, a first joint section being formed between any two of said first recess openings, said thread portion including a coarse thread section extending from said first axial end and a fine thread section extending from said coarse thread section to said second axial end, at least a part of said fine thread section projecting radially from said body portion to vary from said coarse thread section in diametric extent, said fine thread section extending axially toward said second axial end with the diametric extent progressively increasing to flare radially outward, said coarse thread section having a plurality of second recess openings formed thereon, a second joint section being formed between any two of said second recess openings, said first recess openings and said second recess openings being formed by a high-energy optothermal method, said first recess openings of said body portion thereby being spaced from each other by an equal distance and said second recess openings of said coarse thread section thereby being spaced from each other by an equal distance, said first recess openings and said second recess openings receiving accretions after said root implant is located in position.

2. The root implant as claimed in claim 1, wherein at least one first pore is formed on each of said first recess openings.

3. The root implant as claimed in claim 1, wherein at least one second pore is formed on each of said second recess openings.

4. The root implant as claimed in claim 1, wherein said fine thread section has a plurality of third recess openings formed thereon, a third joint section being formed between any two of said third recess openings.

5. The root implant as claimed in claim 4, wherein at least one third pore is formed on each of said third recess openings.

6. The root implant as claimed in claim 1, wherein adjacent threads of the coarse thread section are axially spaced apart to expose a cylindrically-extending outer surface of the body portion, at least some of the first recess openings being formed within said exposed cylindrically-extending outer surface of said body portion.
